(19) United States
(12) Patent Application Publication
(10) Pub. No.: US 2021/0010249 A1
(43) Pub. Date: Jan. 14, 2021

(54) SINK MOUNTED HIGH-PRESSURE WASHER

(71) Applicant: Walter H. Shutt, III, Highland Beach, FL (US)

(72) Inventor: Walter H. Shutt, III, Highland Beach, FL (US)

(21) Appl. No.: 17/030,784

(22) Filed: Sep. 24, 2020

Related U.S. Application Data
(63) Continuation of application No. 16/394,862, filed on Apr. 25, 2019.

(51) Int. Cl. E03C 1/04; B05B 12/00; B05B 9/04; E03C 1/02

(52) U.S. Cl. CPC E03C 1/04; E03C 1/025; B05B 9/0403; B05B 12/002

(57) ABSTRACT

A high pressure sink base water sprayer having a hand-directed spray nozzle on a flexible extensible supply hose. A self-contained electric pressure pump assembly is removably positioned within a sink cabinet and inter-connects to the sink faucet's water supply with an adaptable fitting. A fluid path is established through the pressurization assembly to a nozzle supply hose. Pressurized connections allow for this connection and removal to remote locations and adapt to auxiliary water supply inlets enabling use off site.

This application is a continuation application of Ser. No. 16/394,862, filed Apr. 25, 2019.

### BACKGROUND OF THE INVENTION

### 1. Technical Field

This invention relates to water pressure pumps, specifically electrically operated high-pressure pumps, designed to boost the water supply pressure to an outlet spray nozzle, such as found in pressure washers.

### 2. Description of Prior Art

Prior art devices of this type are typically found on large mobile power washers having a gasoline or electric motor to boost incoming water pressure to hundreds of PSI for pressure washing applications through a spray wand and adapted nozzles.

Other pressure boosting pumps can be found in commercial and some residential applications to boost incoming water pressure for potable and non-potable use such as fire suppression sprinkler systems and the like. Such commercial examples can also be used in high-rise buildings and in any number and variety of water supply plumbing domestic applications, such as well pumps.

Typical prior art discloses a pre-rinse spray water and nozzle system defined as pre-rinse spray valves that are used to rinse dishes before they go into the dishwasher. Such rinse systems have increased flow rates as high as five GPM (gallons per minute). However, current legal flow rates under the EPA Act of 2005 have a maximum rate of 1.6 GPM's.

In contrast, the current disclosure defines a pre-spray wash system using only 0.5 GPM's by utilizing high pressure without the need for hot water quantities as previously required.

Prior art additional examples of patents can be seen in U.S. Pat. Nos. 4,197,872, 4,998,302 and 4,974,500.

U.S. Pat. No. 4,197,872 discloses a high-pressure dispensing system for mixed liquids having a mix inlet, a pressure release valve before connecting to the nozzle.

U.S. Pat. No. 4,998,302 describes a water pump with a self-contained mobile hygiene cabinet.

U.S. Pat. No. 4,974,500 claims a hot beverage preparation and dispensing cart.

Other examples of high-pressure water pump applications can be seen in U.S. Pat. No. 4,433,698 for a parts washer and a booster water spring system illustrated in U.S. Pat. No. 8,487,796 wherein a pump is used to increase the inflow from an outdoor garden water faucet for enhanced water supply spray use.

### SUMMARY OF THE INVENTION

A compact self-contained water pressure pump assembly primarily used under a sink to provide an independent high pressure (800 PSI) to a hand-directed spray nozzle on a flexible supply hose. The pressure pump assembly has compression fittings for attachment to faucet water supply and for ease of adaptability to existing residential plumbing. An electric pump motor supplies power through existing sink appliance switch or an independent switch-controlled outlet or connection.

### DESCRIPTION OF THE DRAWINGS

FIG. 1 is a graphic front elevational view of the sink pressure washer installed under a sink.

FIG. 2 is a top plan view of the sink pressure washer independently.

FIG. 3 is a graphic flow diagram illustrating the sink pressure washer intake and pressurized outflow path.

FIG. 4 is a side elevational view on lines 4-4 FIG. 2.

### DESCRIPTION OF THE PREFERRED EMBODIMENT

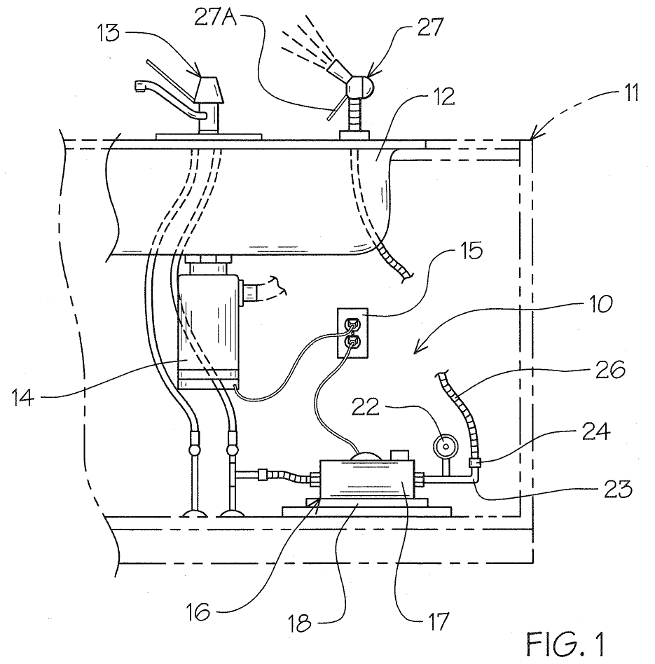

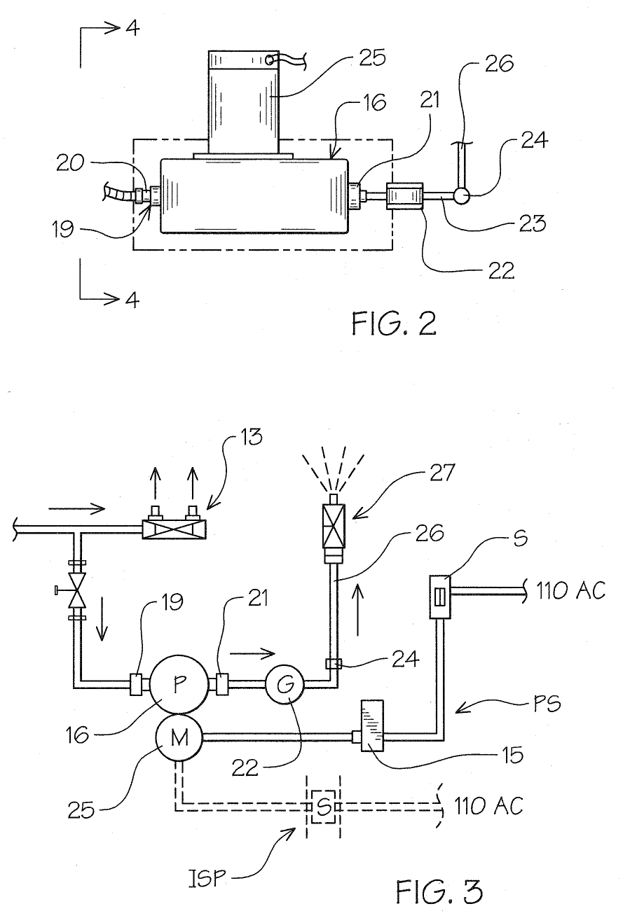

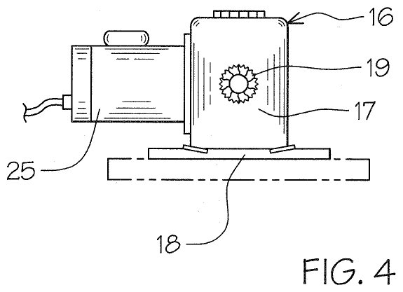

A high pressure sink sprayer assembly 10 of the invention can be seen in FIG. 1 of the drawings, installed within a typical sink base cabinet 11 having a sink 12 with a water outlet faucet 13 positioned thereon. In this example chosen for illustration, a sink mounted garbage disposal 14 is installed with a switch source of power through an under-sink wall power outlet 15. The high-pressure sink sprayer assembly 10 as seen in FIGS. 1, 2 and 4 of the drawings has a water pressure pump 16 with a housing 17 on a mounting bracket base 18. A water pump supply inlet fitting 19 is positioned on the pump housing 17 with compression pipe-type fittings 20, as will be well-known in the art. This type of fitting may also be of a quick connect and release configuration (not shown) allowing for simple disconnection if so required for remote operation, as will be discussed in greater detail hereinafter.

A corresponding water pressure pump outlet fitting 21 is positioned in oppositely disposed relation thereon to supply fluid flow under pressure. A pressure gauge 22 is fitted on an outlet pipe 23 with a free end adaptive hose connection 24.

The water pressure pump 16 requires an integrated electric drive motor 25 and a source of electrical power PS. The motor 25 extends from the pump housing 17 in this example and as noted drives the water pressure pump 16, which typically would be of a rotary impeller type commonly found within the industry. The motor 25 power source shown is the switch electrical wall outlet 15 within the cabinet 11 to which the garbage disposal 14 is also connected and power as is common in the industry.

The pump motor 25 may also be powered by an independent switch power outlet (ISP) if required in specific installation applications in FIG. 3 of the drawings.

A flexible spray hose line 26 extends from the adaptive hose connection 24 as seen in FIG. 1 of the drawings. The hose connection 24 may also be of a quick release as noted.

A high pressure valve spray nozzle 27 is attached to the free end of the spray hose line 26 and removably positioned adjacent the sink faucet 13 for use within the sink 12. The spray nozzle 27 has a control activating valve handle 27A with a nozzle outlet spray pattern to optimize the high-pressure spray and afford proper usage thereof, given the 800 PSI pressure available in this example.

Referring now to the flow diagram in FIG. 3 of the drawings, the water pump drive motor 25 is shown in a directional water flow inlet and pressurized outflow in graphic orientation with power control switching options as hereinbefore described.

It will be evident from the above description that the high-pressure sink sprayer assembly 10 of the invention will provide a unique source of high pressure spray water within a sink based venue, and the utilization of the hand-directed nozzle assembly 27 by proper application and utility can be achieved to wash and clean various items with the advantage of a high pressure self-contained sprayer assembly as described.

It will thus be seen that a new and novel patient fall prevention device has been illustrated and described. It will be apparent to those skilled in the art that various changes and modifications may be made therein without departing from the spirit of the invention. Therefore, I claim:

1. A water pressure pump for commercial and residential applications comprising;
a high-pressure water pump, and a water pump drive motor,
said high pressure water pump configured to produce maximum water pressure of in the range of 700 psi-800 psi,
a supply inlet on said water pump in communication with a water supply conduit,
a pressurized water pump outlet fitting on said water pump,
a flexible water supply hose in direct communication with said water pump fitting,
a remote high-pressure valve spray nozzle in direct communication with said water supply hose,
a source of electrical power for said water pump, a switch in communication with said source of electrical power and said drive motor,
a pressure gauge in communication with said water pump fitting.

2. The water pressure pump set forth in claim 1 wherein said high pressure valve spray nozzle comprises;
a control activation handle.

3. The water pressure pump set forth in claim 1 wherein said source of electrical power comprises;
a switched electrical connection to an electric power system.

4. The water pressure pump set forth in claim 1 wherein said residential application comprises;
a sink, a water outlet faucet on said sink, water conduit supply lines in communication with said faucet, a high-pressure water pump in communication with the water conduit supply lines and a valve spray nozzle and with said high pressure pump.

5. A water spray booster system for use with commercial and residential sinks having hot and cold water supply lines comprises;
a water pump having an electric motor wherein the pump is configured to produce a maximum water pressure of 800 psi,
a water supply inlet fitting on said water pump coupled to one of said water conduit supply lines,
a high-pressure remote spray nozzle removable positioned on the sink,
said spray nozzle in communication with a water pressure outlet on said water pressure pump,
a power source switch in communication with a source of electrical power configured to turn on and off power to the water pressure pump,
a pressure gauge on said pressure outlet on said water pressure pump.

6. The water sprayer booster system set forth in claim 5 wherein said high pressure remote spray nozzle in communication with the water pressure outlet on said water pump further comprises;
a flexible supply hose extending from said spray nozzle to said water pressure pump outlet pressure gauge.
